(19) United States
(12) Patent Application Publication
(10) Pub. No.: US 2011/0027548 A1
(43) Pub. Date: Feb. 3, 2011

(54) Influencing the Near Infrared Reflectance of Dyed Textile Materials

(75) Inventors: Rainer Nusser, Neuenburg (DE); Martin Leiler, Loerrach (DE); Roland Lottenbach, Staad (CH); Hans-Juergen Huebner, Brione s. Minusio (CH)

Correspondence Address: CLARIANT CORPORATION;INTELLECTUAL PROPERTY DEPARTMENT, 4000 MONROE ROAD, CHARLOTTE, NC, 28205, US

(73) Assignees: CLARIANT FINANCE (BVI) LIMITED, Tortola (VG); SCHOELLER TECHNOLOGIES AG, Sevelen (CH)

(21) Appl. No.: 12/934,400

(22) PCT Filed: Mar. 27, 2009
(86) PCT No.: PCT/EP09/53696

§ 371 Date: Sep. 24, 2010

(30) Foreign Application Priority Data
Mar. 28, 2008 (EP) 08153509.8
Mar. 28, 2008 (EP) 08153510.6
Mar. 28, 2008 (EP) 08153511.4
Mar. 28, 2008 (EP) 08153512.2
Mar. 28, 2008 (EP) 08153513.0

(51) Int. Cl. D06P 1/00; D06P 1/02; D06P 1/42; D06P 1/41; B05D 5/08; B32B 3/00

(52) U.S. Cl. 428/201; 8/636; 8/682; 8/683; 8/684; 8/676; 8/657; 8/662; 8/696; 427/265

(57) ABSTRACT

Use of the customary dyes for the type of fibre in question and using the customary dyeing and/or printing processes for the type of fibre in question for minimally reducing, retaining or increasing the NIR reflectance, preferably increasing the NIR reflectance, in the region of electromagnetic radiation of wavelength 700 nm to 1100 nm of textile material in relation to the undyed and untreated textile material, characterized in that metal-free dyes are used.

The invention concerns dyed textile materials having, compared with the same, undyed textile materials, an increased or at least equivalent reflectance of electromagnetic radiation in the near infrared (NIR), in particular dyed textile materials having increased or at least equivalent reflectance of electromagnetic radiation in the region of electromagnetic radiation of wavelength 700 nm to 1100 nm.

Surfaces coloured for aesthetic or else for technical reasons, in particular having a dark colour, and exposed to sunlight have the usually unpleasant property of heating up to a greater or lesser extent. Specifically in comparatively small enclosed spaces, as in a closed vehicle for example, the solar heating-up of surfaces is perceived as extremely unpleasant. The insolated areas heat up to a greater or lesser extent, depending on their degree of solar absorption, and emit their heat as thermal radiation into the interior. Outerwear is another arena where heating up due to insulation can become very unpleasantly noticeable.

EP93377 and JP2006-348414 disclose a textile material coated with a polymer embedding metal particles which reflect thermal radiation. DE19540682 describes a thermally reflective coating comprising binder, pigments and solvent and/or water to control the heating up of materials coated therewith. WO02/12405 discloses a coated sheetlike article having reduced solar absorption wherein the coating consists of a pigment and a binder system. WO02/12405 is another instance where the binding system is mainly responsible for reflecting the NIR radiation. These processes all lead to coated textile materials which are extremely unpleasant when used as surfaces of seats and the like, but in particular when used as a textile material for apparel. The coatings often contain metal particles and/or inorganic pigments which largely contain metals.

It is therefore desirable to finish or dye textile materials such that they only heat up minimally, if at all, on irradiation, in particular on solar irradiation, or even reflect thermal radiation. But in the process the wearing comfort or the handle of these textile materials must not change.

It has now been found that dyeing or printing textile materials with ordinary dyes customary for the particular type of fibre while using the dyeing and/or printing processes customary for the particular type of fibre lead only to a minimal reduction, if at all, in NIR reflectance in the region of electromagnetic radiation of wavelength 700 nm to 1100 nm or even lead to an increased NIR reflectance in the region of electromagnetic radiation of wavelength 700 nm to 1100 nm compared with the undyed substrate on using metal-free dyes.

The present invention accordingly provides a process for minimally reducing, retaining or increasing the NIR reflectance, preferably increasing the NIR reflectance, in the region of electromagnetic radiation of wavelength 700 nm to 1100 nm of textile material in relation to the undyed and untreated textile material while using the customary dyes for the type of fibre in question and while using the customary dyeing and/or printing processes for the type of fibre in question, characterized in that metal-free dyes are used.

The invention also provides a dyeing process using the customary dyes for the type of fibre in question and using the customary dyeing and/or printing processes for the type of fibre in question for minimally reducing, retaining or increasing the NIR reflectance, preferably increasing the NIR reflectance, in the region of electromagnetic radiation of wavelength 700 nm to 1100 nm of textile material in relation to the undyed and untreated textile material, characterized in that metal-free dyes are used.

The invention also provides the use of the customary dyes for the type of fibre in question and using the customary dyeing and/or printing processes for the type of fibre in question for minimally reducing, retaining or increasing the NIR reflectance, preferably increasing the NIR reflectance, in the region of electromagnetic radiation of wavelength 700 nm to 1100 nm of textile material in relation to the undyed and untreated textile material, characterized in that metal-free dyes are used.

The invention also provides a textile material characterized in that it is dyed by a dyeing process using the customary dyes for the type of fibre in question and using the customary dyeing and/or printing processes for the type of fibre in question for minimally reducing, retaining or increasing the NIR reflectance, preferably increasing the NIR reflectance, in the region of electromagnetic radiation of wavelength 700 nm to 1100 nm of textile material in relation to the undyed and untreated textile material, characterized in that metal-free dyes are used.

Minimal reduction means that the reflectance does not decrease by more than 5% age points (absolute) compared with the untreated substrate (textile material).

Increasing the NIR reflectance means that the reflectance of the NIR of the treated substrate (textile material) is higher, preferably by more than 2% age points (absolute), more preferably by more than 5% age points (absolute) compared with the untreated substrate (textile material).

The present invention provides a process witch utilizes metal-free customary dyes for the type of fibre in question and relates to the use of metal-free customary dyes for the type of fibre in question for minimally reducing, retaining or increasing the NIR reflectance, preferably increasing the NIR reflectance, in the region of electromagnetic radiation of wavelength 700 nm to 1100 nm of textile material in relation to the undyed and untreated textile material.

The invention also provides the use of the customary dyes for the type of fibre in question and using the customary dyeing and/or printing processes for the type of fibre in question for minimally reducing, retaining or increasing the NIR reflectance, preferably increasing the NIR reflectance, in the region of electromagnetic radiation of wavelength 700 nm to 1100 nm of textile material in relation to the undyed and untreated textile material

In a first embodiment the process of the present invention preferably utilizes metal-free acid dyes and relates to the use of metal-free acid dyes for minimally reducing, retaining or increasing the NIR reflectance, preferably increasing the NIR reflectance, in the region of electromagnetic radiation of wavelength 700 nm to 1100 nm of textile material in relation to the undyed and untreated textile material.

In a second embodiment the process of the present invention preferably utilizes metal-free basic dyes and relates to the use of metal-free basic dyes for minimally reducing, retaining or increasing the NIR reflectance, preferably increasing the NIR reflectance, in the region of electromagnetic radiation of wavelength 700 nm to 1100 nm of textile material in relation to the undyed and untreated textile material.

In a third embodiment the process of the present invention preferably utilizes metal-free disperse dyes and relates to the use of metal-free basic dyes for minimally reducing, retaining or increasing the NIR reflectance, preferably increasing the NIR reflectance, in the region of electromagnetic radiation of wavelength 700 nm to 1100 nm of textile material in relation to the undyed and untreated textile material.

In a fourth embodiment the process of the present invention preferably utilizes metal-free pigments and relates to the use of metal-free pigments for minimally reducing, retaining or increasing the NIR reflectance, preferably increasing the NIR reflectance, in the region of electromagnetic radiation of wavelength 700 nm to 1100 nm of textile material in relation to the undyed and untreated textile material.

In a fifth embodiment the process of the present invention preferably utilizes metal-free reactive dyes and relates to the use of metal-free pigments for minimally reducing, retaining or increasing the NIR reflectance, preferably increasing the NIR reflectance, in the region of electromagnetic radiation of wavelength 700 nm to 1100 nm of textile material in relation to the undyed and untreated textile material.

Metal-free acid dyes of the first embodiment are those acid dyes which are listed as Acid Dyes in the Color Index International and are metal free or all metal-free dyes which are water-soluble, synthetic dyes which in the exhaust dyeing process go onto the fibre from the acidic, rarely neutral dyeing liquor and produce the hue without further aftertreatment. Preferred acid dyes are acid dyes from the class of the azo dyes, triarylmethane dyes, anthraquinone dyes, nitro dyes, pyrazolone dyes, quinoline dyes, naphthol dyes and phenazine dyes; particular preference is given to acid dyes from the nitro, monoazo, disazo and anthraquinone series.

Particularly preferred acid dyes have one of the following structures (A-I), (A-II), (A-III), (A-IV) or (A-V)

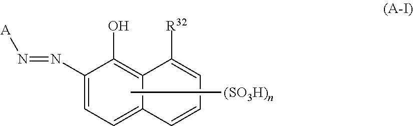

where
A is an unsubstituted or substituted naphthyl radical or an unsubstituted or substituted phenyl radical,
R³² is hydrogen, hydroxyl, amino or an unsubstituted or substituted naphthyl radical or an unsubstituted or substituted phenyl radical, and
n is 1, 2 or 3.

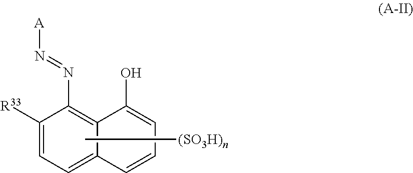

where
A is an unsubstituted or substituted naphthyl radical or an unsubstituted or substituted phenyl radical,
R³³ is hydrogen, hydroxyl, amino or an unsubstituted or substituted naphthyl radical or an unsubstituted or substituted phenyl radical, and
n is 1, 2 or 3.

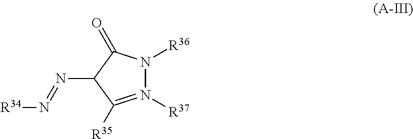

where
R³⁴, R³⁵, R³⁶, R³⁷ are each hydrogen, hydroxyl, amino, substituted or unsubstituted C₁ to C₄ alkyl, or an unsubstituted or substituted naphthyl radical or an unsubstituted or substituted phenyl radical and the dye of formula (III) bears one, two or three sulpho groups.

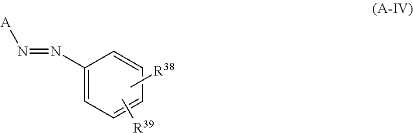

where
A, R³⁸, R³⁹ are each hydrogen, hydroxyl, amino, substituted or unsubstituted C₁ to C₄ alkyl, or an unsubstituted or substituted naphthyl radical or an unsubstituted or substituted phenyl radical and the dye of formula (IV) bears one, two or three sulpho groups.

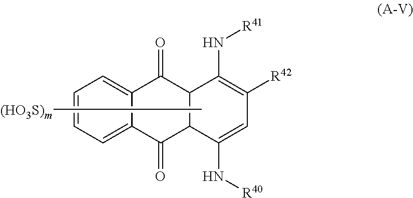

where
R⁴⁰, R⁴¹, R⁴² are each hydrogen, hydroxyl, amino, substituted or unsubstituted C₁ to C₄ alkyl, or an unsubstituted or substituted naphthyl radical or an unsubstituted or substituted phenyl radical,
m is 0, 1, 2 or 3 and the dye of formula (A-V) bears one, two or three sulpho groups.

The invention also provides the use of the customary dyes for the type of fibre in question and using the customary dyeing and/or printing processes for the type of fibre in question for minimally reducing, retaining or increasing the NIR reflectance, preferably increasing the NIR reflectance, in the region of electromagnetic radiation of wavelength 700 nm to 1100 nm of textile material in relation to the undyed and untreated textile material, characterized in that metal-free acid dyes have the structures (A-I), (A-II), (A-III), (A-IV) or (A-V).

Preferably the textile material which is dyes with the metal-free acid dyes which have the structures (A-I), (A-II), (A-III), (A-IV) or (A-V) consists of nylon or wool, and synthetic PA6 (nylon-6) or else PA66 (nylon-6,6) can be used in the process of the present invention. The substrate to be dyed can be for example in the form of sheetlike or threadlike structures, i.e. in the form of yarn, woven fabric, knitted fabric or carpet. Fully-fashioned dyeings are even very readily possible on delicate substrates, for example lambswool, cashmere, alpaca and mohair. The process of the present invention is particularly useful for dyeing fine-denier fibres (microfibres).

Dyeing using the dyes which have the structures (A-I), (A-II), (A-III), (A-IV) or (A-V) is carried out in accordance with known processes; reference is made by way of example to the dyeing processes described in Ullmanns Encyklopädie der technischen Chemie, 4th edition, 1982, Volume 22, pages 658-673 or in the book by M. Peter and H. K. Rouette, Grundlagen der Textilveredlung, 13th edition, 1989, pages 535-556 and 566-574. Preference is given to dyeing by the exhaust method at a temperature of 30 to 140° C., more preferably 80 to 120° C. and most preferably at a temperature of 80 to 100° C., and at a liquor ratio of 3:1 to 40:1. The dyes of the process according to the invention can also be applied by printing, whether by traditional (classic) textile-printing processes or else by contactless printing, as by the ink jet process for example.

Basic dyes or cationic dyes of the second embodiment are dyes whose amino groups (which may also be substituted) are included in the resonance of the chromophore (formation of the ammonium group). They may be xanthene, phenazine, phenoxazine, thiazine, polymethine and also diarylcarbenium and triarylmethane dyes which are in the form of salts (for example chlorides). Preferred basic dyes are basic dyes from the azo, bisazo, ketoimine, polymethine, acridine, xanthene, azine, thiazine, cyanine, thiazole, triarylmethane and anthraquinone series.

Particularly preferred basic dyes have one of the following structures (B-I), (B-II), (B-M), (B-IV) or (B-V)

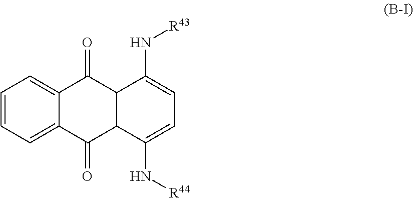

where
R⁴³ and R⁴⁴ are independently substituted or unsubstituted C₁ to C₄ alkyl, substituted or unsubstituted —(C₁₋₄ alkylene)-N⁺-(C₁₋₄ alkyl)₂, the dye of the formula (B-I) being at least singly or doubly positively charged;

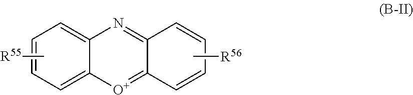

where
R⁵⁵ and R⁵⁶ are independently substituted or unsubstituted C₁ to C₄ alkyl, substituted or unsubstituted —N—(C₁₋₄ alkyl)₂;

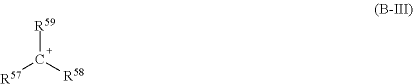

where
R⁵⁷ and R⁵⁸ are independently substituted or unsubstituted phenyl, substituted or unsubstituted naphthyl, and
R⁵⁹ is independently substituted or unsubstituted phenyl, substituted or unsubstituted naphthyl or ═N⁺H₂;

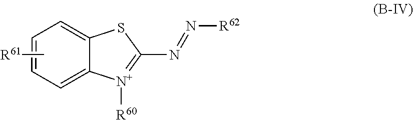

where
R⁶⁰ is (C₁₋₄ alkyl)-C(O)NH₂
R⁶¹ is C₁₋₄ alkyl or C₁₋₄ alkoxy, and
R⁶² is substituted or unsubstituted phenyl, substituted or unsubstituted naphthyl.

The invention also provides the use of the customary dyes for the type of fibre in question and using the customary dyeing and/or printing processes for the type of fibre in question for minimally reducing, retaining or increasing the NIR reflectance, preferably increasing the NIR reflectance, in the region of electromagnetic radiation of wavelength 700 nm to 1100 nm of textile material in relation to the undyed and untreated textile material, characterized in that metal-free acid dyes have the structures (B-I), (B-II), (B-III), (B-IV) or (B-V).

Useful anions for the dyes of the structures (B-I), (B-II), (B-III), (B-IV) or (B-V) include chlorides, bromides, sulphates, carbonates and organic carboxylates. Dyes of the structures (B-I), (B-II), (B-III), (B-IV) or (B-V) containing free basic groups can also be converted into water-soluble salts by converting the dyes which contain free basic groups with inorganic or organic acids. As examples there may be mentioned for example acetic acid, lactic acid, formic acid, hydrochloric acid, sulphuric acid.

Preferred textile materials which is dyes by the dyes of the structures (B-I), (B-II), (B-III), (B-IV) or (B-V) consist of polyacrylonitrile fibres, the so-called polyacrylic fibres or acrylic fibres. These preferred polyacrylonitrile fibres consist of not less than 85% of acrylonitrile units and are preferably terpolymers composed of acrylonitrile (89-95%), a nonionic comonomer (4-10%, for example vinyl chloride, methyl methacrylate) and an ionic comonomer (0.5-1%, for example vinylsulphonic acid, styrenesulphonic acid, vinylpyridine). Textile materials composed of anionically modified polyester fibres can also be used.

Dyeing using the dyes of the structures (B-I), (B-II), (B-III), (B-IV) or (B-V) is carried out in accordance with known processes, described for example in M. Peter and H. K. Rouette: “Grundlagen der Textilveredelung; Handbuch der Technologie, Verfahren and Maschinen”, 13th revised edition, 1989, Deutscher Fachverlag GmbH, Frankfurt/Main, Germany, ISBN 3-87150-277-4, wherein pages 602 to 606 (chapters 7.222.35, 7.222.351 and 7.222.351.1) are of particular interest. The exhaust process or else the padding process can be used.

The dyes of the structures (B-I), (B-II), (B-III), (B-IV) or (B-V) of the process according to the present invention can also be applied by printing, whether with conventional (classic) textile printing processes or else by contactless printing, as by ink jet printing for example.

The disperse dyes of the third embodiment are dyes which are a sparing solubility in water, i.e. not more than 200 mg per litre, and which are used together with dispersants in a very finely ground state for dyeing and printing semisynthetic or synthetic hydrophobic fibre materials, preferably for dyeing and printing synthetic hydrophobic fibre materials. In the process of the present invention, the molecularly dissolved portions of the preferred dyes penetrate in the dyebath into the fibre by diffusion, form a solid solution therein and thereby produce fast dyeings.

The disperse dyes of the third embodiment are disperse dyes selected from the azo, bisazo, nitro, anthraquinone, polymethine, coumarin, and naphthalimide series.

It is particularly preferable to perform the process and to use in the third embodiment of the present invention disperse dyes have the following dyes of the formula (C-1) or (C-2) or (C-3) or (C-4) or (C-5) or (C-6) or (C-7) or (C-8) or (C-9) or (C-10) or (C-11) or (C-12):

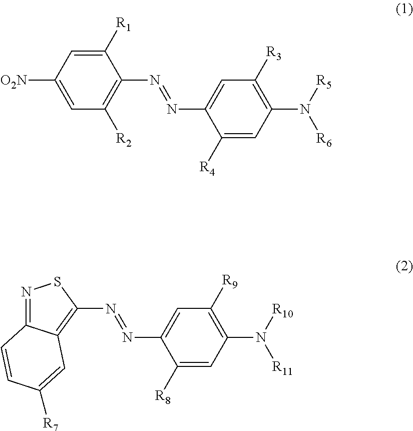

where
R₁ is hydrogen, halogen, nitro or cyano
R₂ is hydrogen, halogen, nitro or cyano
R₃ is hydrogen, halogen, C₁-C₄-alkoxy or C₁-C₄-alkyl
R₄ is hydrogen, C₁-C₄-alkyl,
R₅ is hydrogen, unsubstituted or hydroxyl-, cyano-, C₁-C₄-alkylcarbonyloxy-substituted C₁-C₄-alkyl or C₁-C₄-alkenyl,
R₆ is unsubstituted or hydroxyl-, cyano-, C₁-C₄-alkylcarbonyloxy-, alkoxycarbonyl-substituted C₁-C₄-alkyl or C₁-C₄-alkenyl,
R₇ is nitro, C₁-C₄-alkoxy or the radical —SO₂CH₃,
R₈ is hydrogen or C₁-C₄-alkyl,
R₉ is hydrogen or C₁-C₄-alkyl,
R₁₀ is unsubstituted or hydroxyl- or cyano-substituted C₁-C₄-alkyl,
R₁₁ is unsubstituted C₁-C₄-alkyl or C₁-C₄-alkyl substituted by the radical —O—COR₁₂, where R₁₂ is C₁-C₄-alkyl;

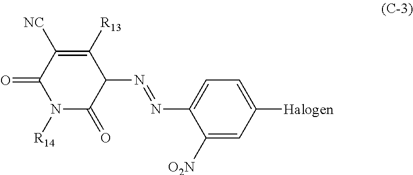

where
R₁₃ is C₁-C₄-alkyl,
R₁₄ is C₁-C₄-alkyl, and
Halogen represents the halogen atoms;

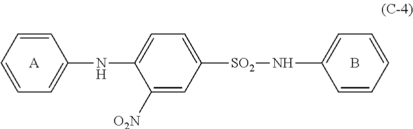

where the rings A and B may be further substituted;

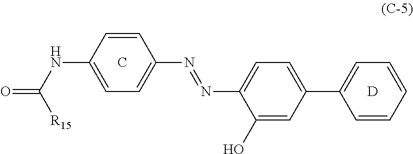

where
R₁₅ is C₁-C₄-alkyl and
   the rings C and D may be further substituted;

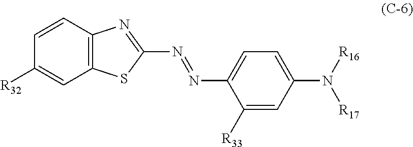

where
R₁₆ is unsubstituted or hydroxyl- or cyano-substituted C₁-C₄-alkyl,
R₁₇ is unsubstituted C₁-C₄-alkyl or C₁-C₄-alkyl substituted by the radical —O—COR₁₈, where R₁₈ is C₁-C₄-alkyl,
R₃₂ is nitro, C₁-C₄-alkoxy or the radical —SO₂CH₃, and
R₃₃ is hydrogen or C₁-C₄-alkyl;

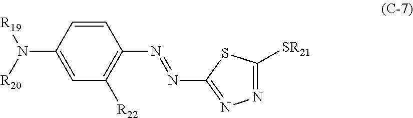

where
R₁₉ is C₁-C₄-alkyl,
R₂₀ is C₁-C₄-alkyl,
R₂₁ is C₁-C₄-alkyl, and
R₂₂ is C₁-C₄-alkyl or the radical —NHCOR₂₃ where R₂₃ is C₁-C₄-alkyl;

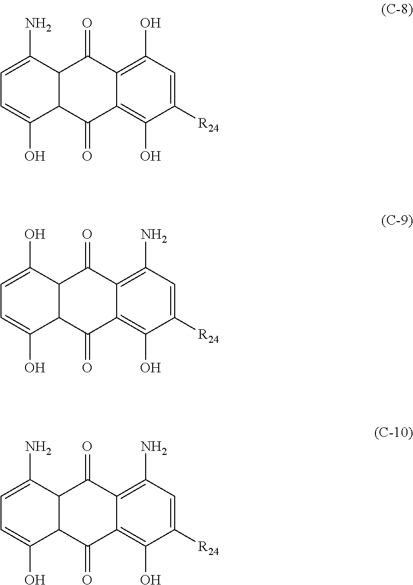

where R₂₄ is halogen;

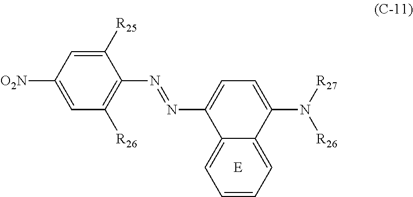

where
R₂₅ is cyano, nitro or halogen,
R₂₆ is halogen,
R₂₇ is unsubstituted or hydroxyl-substituted C₁-C₄-alkyl, and
R₂₈ is unsubstituted or hydroxyl-substituted C₁-C₄-alkyl, and
the naphthyl ring E may be further substituted,
and/or

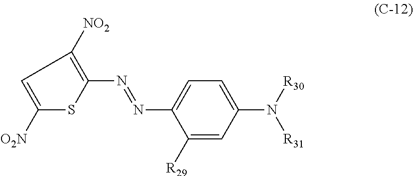

where
R₂₉ is C₁-C₄-alkyl or the radical NHCOR₁₇ where R¹⁷ is C₁-C₄-alkyl,
R₃₀ is C₁-C₄-alkyl or C₁-C₄-alkylcarbonyloxy-C₁-C₄-alkyl, and
R₃₁ is C₁-C₄-alkyl or C₁-C₄-alkylcarbonyloxy-C₁-C₄-alkyl.

C₁-C₄-Alkyl as such and as a radical in C₁-C₄-alkylcarbonylamino or C₁-C₄-alkylcarbonyloxy is methyl, ethyl, propyl, isopropyl, n-butyl, isobutyl, sec-butyl or tert-butyl.

C₁-C₄-Alkoxy as such or as a radical in C₁-C₄-alkoxycarbonyl is for example methoxy, ethoxy, propoxy or butoxy.

Halogens R₁, R₃, R₂₅ and R₂₆ are for example bromine or preferably chlorine.

Halogens R₂ and R₂₄ are for example chlorine or preferably bromine.

Halogen in the formula (3) is for example bromine or preferably chlorine.

C₁-C₄-Alkyls R₅, R₆ and R₁₆ are propyl or isopropyl and in particular ethyl.

C₁-C₄-Alkyls R₁₃, R₁₅, R₁₈, R₂₂, R₂₃, R₈, R₃₁ and R₃₃ are preferably ethyl and especially methyl.

C₁-C₄-Alkyls R₁₄, R₁₉, R₂₁, R₁₁, R₃₀ and R₂₅ are preferably methyl and especially ethyl.

C₁-C₄-Alkyls R₁₉, R₂₀, R₂₇ and R₂₈ are preferably ethyl and especially propyl.

R₃₀ and R₃₁ are preferably C₁-C₄-alkyl.

R₂₆ is preferably nitro or the radical —SO₂CH₃.

The C₁-C₄-alkyl radicals are generally substituted one or two times with the aforementioned substituents.

The rings A to E may be independently substituted for example by C₁-C₄-alkyl, C₁-C₄-alkoxy, halogen, nitro, cyano or acylamino.

The invention also provides the use of the customary dyes for the type of fibre in question and using the customary dyeing and/or printing processes for the type of fibre in question for minimally reducing, retaining or increasing the NIR reflectance, preferably increasing the NIR reflectance, in the region of electromagnetic radiation of wavelength 700 nm to 1100 nm of textile material in relation to the undyed and untreated textile material, characterized in that metal-free disperse dyes have the structures of the formula (C-1) or (C-2) or (C-3) or (C-4) or (C-5) or (C-6) or (C-7) or (C-8) or (C-9) or (C-10) or (C-11) or (C-12).

Preferably the textile material dyed with metal-free disperse dyes with the structures of the formula (C-1) or (C-2) or (C-3) or (C-4) or (C-5) or (C-6) or (C-7) or (C-8) or (C-9) or (C-10) or (C-11) or (C-12) consists of semisynthetic and preferably synthetic hydrophobic fibre materials.

Useful semisynthetic textile materials are in main secondary cellulose acetate, cellulose triacetate, polyamides and macromolecular polyesters and also blends thereof with cellulose.

Synthetic hydrophobic textile materials consist in the main of linear aromatic polyesters, for example those formed from terephthalic acid and glycols, in particular ethylene glycol, or condensate of terephthalic acid and 1,4-bis(hydroxymethyl)-cyclohexane, of polycarbonates, for example those of α,α-dimethyl-4,4′-dihydroxydiphenylmethane and phosgene, and of fibres based on polyvinyl chloride and polyamide.

The textile materials can be present as sheet or thread structures and can have been processed for example into yarns or woven, knitted or loop material. The textile materials can be present in the form of microfibres.

The process of the present invention comprises dyeing or printing textile materials with metal-free disperse dyes with the structures of the formula (C-1) or (C-2) or (C-3) or (C-4) or (C-5) or (C-6) or (C-7) or (C-8) or (C-9) or (C-10) or (C-11) or (C-12) by conventional processes, for example those in accordance with French patent application No. 1.445.371.

Typically, polyester fibre materials are dyed from an aqueous dispersion by the exhaust process in the presence of customary anionic or nonionic dispersants and in the presence or absence of customary swelling agents (carriers) in the temperature range from 65° C. to 140° C.

Secondary cellulose acetate is preferably dyed at a temperature from 65° C. to 85° C. and cellulose triacetate at temperatures up to 115° C.

The metal-free disperse dyes with the structures of the formula (C-1) or (C-2) or (C-3) or (C-4) or (C-5) or (C-6) or (C-7) or (C-8) or (C-9) or (C-10) or (C-11) or (C-12) are suitable for dyeing by the thermosol process, for the exhaust process, the continuous process and for printing as for modern imaging processes, for example thermal transfer printing, inkjet printing, hot melt inkjet printing or by conventional printing processes.

The thermosol process, the exhaust process and the continuous process are well-known dyeing processes and are described for example in M. Peter and H. K. Rouette: “Grundlagen der Textilveredelung; Handbuch der Technologie, Verfahren and Maschinen”, 13th revised edition, 1989, Deutscher Fachverlag GmbH, Frankfurt/Main, Germany, ISBN 3-87150-277-4, wherein the following pages are of particular interest: pages 460-461, 482-495, 556-566 and 574-587.

The dyeings with metal-free disperse dyes with the structures of the formula (C-1) or (C-2) or (C-3) or (C-4) or (C-5) or (C-6) or (C-7) or (C-8) or (C-9) or (C-10) or (C-11) or (C-12) are carried out from an aqueous liquor by the exhaust process, and the liquor ratio can be chosen within wide limits, for example in the range from 4:1 to 100:1 and preferably in the range from 6:1 to 50:1.

The dyeing time is in the range from 20 to 90 minutes and preferably in the range from 30 to 60 minutes.

The dyeing liquors may additionally comprise further additives, for example dyeing auxiliaries, dispersants, wetting agents and antifoams.

The liquor may also comprise mineral acids, such as sulphuric acid or phosphoric acid, or advantageously also organic acids, for example formic acid or acetic acid and/or salts thereof, such as ammonium acetate, ammonium sulphate or sodium sulphate. The acids mainly serve to adjust the dyeing liquors to a pH which is preferably in the range from 4 to 5.

The metal-free disperse dyes with the structures of the formula (C-1) or (C-2) or (C-3) or (C-4) or (C-5) or (C-6) or (C-7) or (C-8) or (C-9) or (C-10) or (C-11) or (C-12) are usually present in the dyeing liquors in the form of a fine dispersion. Suitable dispersants for preparing this dispersion are for example anionic dispersants, such as aromatic sulphonic acid-formaldehyde condensates, sulphonated cresol oil-formaldehyde condensates, ligninsulphonates or copolymers of acrylic acid derivatives, preferably aromatic sulphonic acid-formaldehyde condensates or ligninsulphonate, or nonionic dispersants based on polyalkylene oxides, for example obtainable by polyaddition of ethylene oxide or propylene oxide. Suitable dispersants are further recited in U.S. Pat. No. 4,895,981 or in U.S. Pat. No. 5,910,624.

The pigments of the fourth embodiment preferably are metal-free pigments. Preferred organic pigments according to the fourth embodiment are pigments from the azo, bisazo, aminoketone, benzimidazolone, polymethine, acridine, xanthene, azine, thiazine, cyanine, thiazole, indanthrene and anthraquinone series.

Particularly preferred pigments according to the fourth embodiment are those pigments which in the Colour Index (C.I.) have pigment as part of the Colour Index Generic Name.

The invention also provides the use of the customary dyes for the type of fibre in question and using the customary dyeing and/or printing processes for the type of fibre in question for minimally reducing, retaining or increasing the NIR reflectance, preferably increasing the NIR reflectance, in the region of electromagnetic radiation of wavelength 700 nm to 1100 nm of textile material in relation to the undyed and untreated textile material, characterized in that metal-free organic are pigments from the azo, bisazo, aminoketone, benzimidazolone, polymethine, acridine, xanthene, azine, thiazine, cyanine, thiazole, indanthrene and anthraquinone series.

Preferred textile materials which are dyed with the pigments according to the fourth embodiment consist of polyacrylonitrile fibres, the so-called polyacrylic fibres or acrylic fibres. These preferred polyacrylonitrile fibres consist of not less than 85% of acrylonitrile units and are preferably terpolymers composed of acrylonitrile (89-95%), a nonionic comonomer (4-10%, for example vinyl chloride, methyl methacrylate) and an ionic comonomer (0.5-1%, for example vinylsulphonic acid, styrenesulphonic acid, vinylpyridine). Textile materials composed of anionically modified polyester fibres can also be used.

Dyeing is carried out as mass colouration in accordance with known processes. In this so-called spin or solution dyeing, the spinning solution or melt used in the production of manufactured fibres is mixed—usually in the form of masterbatches—with pigment dyes which remain in the fibre at coagulation and thereby dye/colour the fibre. This well-known dyeing process is described for example in WO2004/022633 or WO2006/003121 or in Industrial Organic Pigments. Production, Properties, Applications by Willy Herbst (author), Klaus Hunger (author) publishers: Wiley-VCH; 3rd revised edition (February 2004) ISBN-10: 3527305769, ISBN-13: 978-3527305766 on pages 176 to 179 (the chapter 1.8.3.8 Spin Dyeing, in particular the section on polyacrylonitrile (PAC)).

The dyes of the fifth embodiment preferably uses metal-free dyes which contain as well as a colour-conferring component (chromophore) and contain a specific reactive component via which they react with functional groups on the fibre (for example hydroxyl groups in the case of cellulose or amide groups in the case of wool and nylons) and become covalently bonded thereto. Therefore, the process of the present invention preferably utilizes reactive dyes and the fifth embodiment relates to the use of reactive dyes.

Preferred reactive dyes according to the fifth embodiment preferably come from the azo (monoazo, disazo), anthraquinone and phenoxazine series, and particularly preferred reactive dyes from the monoazo, disazo and anthraquinone series. The reactive component of the dyes according to the fifth embodiment which are used in the process of the present invention comprises halogenated, unsaturated, usually heterocyclic radicals such as for example 1,3,5-triazines, pyrazines, pyrimidines, the halogen atoms reacting in an alkaline medium with hydroxyl groups on the cellulose by hydrogen halide elimination and formation of ester-type bonds, on the one hand and, on the other, hydrogensulphate or sulphamate esters, for example of 3-hydroxypropionamido and 2-hydroxyethylsulphonyl groups, these esters in an alkaline medium spontaneously detaching sulphate and converting into acrylamido or vinylsulphonyl groups which in turn combine with hydroxyl groups on the cellulose to form stable ethers.

Particularly preferred reactive dyes according to the fifth embodiment preferably have one of the following structures (E-I), (E-II), (E-III), (E-IV), (E-V) or (E-VI)

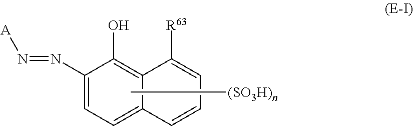

where
A is an unsubstituted or substituted naphthyl radical or an unsubstituted or substituted phenyl radical,
R⁶³ is hydrogen, hydroxyl, amino, an amine substituted by unsubstituted or substituted naphthyl or by unsubstituted or substituted phenyl, or an unsubstituted or substituted naphthyl radical or an unsubstituted or substituted phenyl radical,
n is 1 or 2 and the dye of formula (E-I) bears one or two fibre-reactive groups;

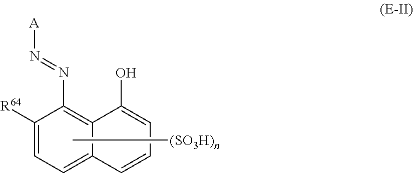

where
A is an unsubstituted or substituted naphthyl radical or an unsubstituted or substituted phenyl radical,
R⁶⁴ is hydrogen, hydroxyl, amino, an amine substituted by unsubstituted or substituted naphthyl or by unsubstituted or substituted phenyl, or an unsubstituted or substituted naphthyl radical or an unsubstituted or substituted phenyl radical,
n is 1, 2 or 3 and the dye of formula (E-II) bears one or two fibre-reactive groups;

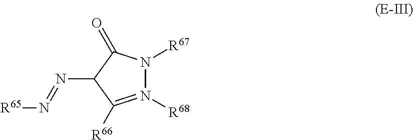

where
R⁶⁵, R⁶⁶, R⁶⁷, R⁶⁸ are each hydrogen, hydroxyl, amino, substituted or unsubstituted C₁ to C₄ alkyl, or an unsubstituted or substituted naphthyl radical or an unsubstituted or substituted phenyl radical and the dye of formula (E-III) bears one, two or three sulpho groups and also one or two fibre-reactive groups;

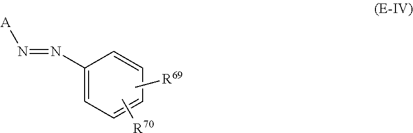

where
A, R⁶⁹, R⁷⁰ are each hydrogen, hydroxyl, amino, an amine substituted by unsubstituted or substituted naphthyl or by unsubstituted or substituted phenyl, or an unsubstituted or substituted naphthyl radical or an unsubstituted or substituted phenyl radical and the dye of formula (E-IV) bears one, two or three sulpho groups and also one or two fibre-reactive groups;

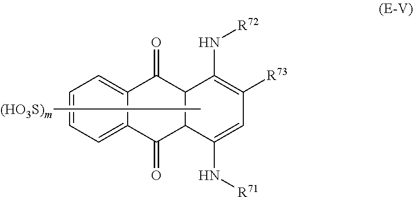

where
R⁷¹, R⁷², R⁷³ are each hydrogen, hydroxyl, amino, substituted or unsubstituted C₁ to C₄ alkyl, or an unsubstituted or substituted naphthyl radical or an unsubstituted or substituted phenyl radical
m is 0, 1, 2 or 3 and the dye of formula (E-V) bears one, two or three sulpho groups and also one or two fibre-reactive groups;

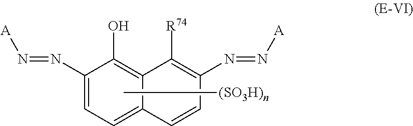

where
A in each occurrence is independently an unsubstituted or substituted naphthyl radical or an unsubstituted or substituted phenyl radical,
R⁷⁴ is hydroxyl, amino, an amine substituted by unsubstituted or substituted naphthyl or by unsubstituted or substituted phenyl, or an unsubstituted or substituted naphthyl radical or an unsubstituted or substituted phenyl radical,
n is 1 or 2 and the dye of formula (E-VI) bears one or two fibre-reactive groups.

The invention also provides the use of the customary dyes for the type of fibre in question and using the customary dyeing and/or printing processes for the type of fibre in question for minimally reducing, retaining or increasing the NIR reflectance, preferably increasing the NIR reflectance, in the region of electromagnetic radiation of wavelength 700 nm to 1100 nm of textile material in relation to the undyed and untreated textile material, characterized in that metal-free dyes are reactive dyes.

Preferred substrates for use in the process of the present invention are textile materials dyed according to the fifth embodiment preferably were dyed with dyes having one of the structures (E-I), (E-II), (E-III), (E-IV), (E-V) or (E-VI), and the substrates consisting of or containing natural or synthetic polyamides or natural or rejuvenated cellulose, such as cotton, filament viscose or staple viscose.

The most preferred substrate is textile material that are dyed using the dyes according to the fifth embodiment consisting of or containing cotton.

The dyes of the process according to the fifth embodiment of the present invention can be used in dyeing liquors or in printing pastes according to any dyeing or printing method customary for reactive dyes. Preference is given to dyeing by the exhaust method, in which case a temperature interval of 30-98° C. is used, but the temperature does depend on the identity of the reactive hook.

Hot-dyeing dyes (60-98° C.) are not very reactive and have to be activated by high temperature and also strong alkali. They include for example monochlorotriazinyl, trichloropyrimidyl and tetrachloropyrimidyl dyes.

Cold-dyeing dyes (40-60° C.) are highly reactive dyes having dichlorotriazinyl, chlorodifluoropyrimidyl, difluoropyrimidyl or dichloroquinoxaline hooks, which react with the fibre without strong alkali and at relatively low temperatures.

In accordance with another aspect to the fifth embodiment of the present invention there is accordingly provided a process for dyeing or printing hydroxyl-containing or nitrogenous organic substrates wherein dyeing or printing is effected with the above-defined compounds, their salts or mixtures thereof.

In accordance with a further aspect of the fifth embodiment of the present invention there is claimed a hydroxyl-containing or nitrogenous organic substrate dyed or printed in accordance with the dyeing or printing process described above.

Also claimed are substrates, in particular cellulose, nylons and animal fibres, preferably cotton, dyed or printed with such compounds.

Similarly paper and optionally pretreated substrates containing cellulose, nylons or animal fibres and printed with ink jet printing inks containing such compounds, their salts or mixtures.

Conventional (classic) printing processes are known per se and differ in the way the printing ink or paste is transferred to the substrate. For example, inks or pastes can be applied by raised type as for example in letterpress and flexographic printing, from a planar surface in lithographic printing, from a recessed surface (intaglio) or through a stencil (silk screen). Different methods of application and different substrates require different properties of the ink.

In the inkjet printing process, individual droplets of the ink are sprayed from a nozzle onto a substrate in a controlled manner. The continuous inkjet method and the drop-on-demand method are employed predominantly for this purpose. In the case of the continuous inkjet method, the droplets are produced continuously and droplets not needed for printing are diverted into a collecting vessel and recycled. In the case of the discontinuous drop-on-demand method, by contrast, droplets are generated and printed as desired, i.e. droplets are only generated when this is necessary for printing. The droplets may be generated for example by means of a piezo inkjet head or by means of thermal energy (bubble jet).

In hot melt inkjet printing, solid hot melt inks are loaded into a printer capable of melting the ink in the inkjet printer head, injecting the liquid ink which quickly resolidifies upon impacting a substrate. Conventional hot melt inkjet printers operate with a printing head and inkjet temperature of about 120 to 150° C. At these temperatures, the solid ink melts to form a liquid of low viscosity, generally 8 to 25 cP at the jetting temperature.

In the inkjet printing process, individual droplets of the ink are sprayed from a nozzle onto a substrate in a controlled manner. The continuous inkjet method and the drop-on-demand method are employed predominantly for this purpose. In the case of the continuous inkjet method, the droplets are produced continuously and droplets not needed for printing are diverted into a collecting vessel and recycled. In the case of the discontinuous drop-on-demand method, by contrast, droplets are generated and printed as desired, i.e. droplets are only generated when this is necessary for printing. The droplets may be generated for example by means of a piezo inkjet head or by means of thermal energy (bubble jet).

In hot melt inkjet printing, solid hot melt inks are loaded into a printer capable of melting the ink in the inkjet printer head, injecting the liquid ink which quickly resolidifies upon impacting a substrate. Conventional hot melt inkjet printers operate with a printing head and inkjet temperature of about 120 to 150° C. At these temperatures, the solid ink melts to form a liquid of low viscosity, generally 8 to 25 cP at the jetting temperature.

The present invention additionally provides a method of increasing the sun protection factor (SPF) rating of cellulosic or protein fiber or fabric.

Cellulosic fibres may be any fibres of plant origin such as cotton, viscose, flax, linen, rayon or the like or composites thereof. Also, composites can be with polyester, polyamides, polyacrylonitriles or the like. Also, composites can be with polyester, polyamide or the like.

Protein fibres may be any fibres of animal origin such as wool, mohair, silk, cashmere, angora or the like or composites thereof. Also, composites can be with polyester, polyamide or the like.

The fabrics may be made of any fibres of plant origin such as cotton, viscose, flax, linen, rayon or the like or composites thereof. Also, composites can be with polyester, polyamides, polyacrylonitriles or the like.

The fabrics may be made of any fibres of animal origin such as wool, mohair, silk, cashmere, angora or the like or composites thereof. Also, composites can be with polyester, polyamide or the like.

Essentially, the SPF protection of a fabric depends on the “Cover Factor” of the fabric. The Cover Factor may be defined as the percentage of the fabric surface that is covered by the yarns of the fabric. If one assumes that the yarns employed to weave or knit the fabric are completely opaque to UVR radiation (which is not the case in reality) then the fabric SPF would be simply related to Cover Factor by the following formula:

$$Fabric SPF = \frac{100}{100 - Cover Factor}$$

The method of increasing the SPF rating of fibers or fabrics comprises the use of the compounds (I) to (IV) as described in WO94/04515. WO94/04515 is herewith incorporated by reference.

The method of increasing the SPF rating of fibers or fabrics comprises applying to the fibers or fabrics one or more compounds of formula

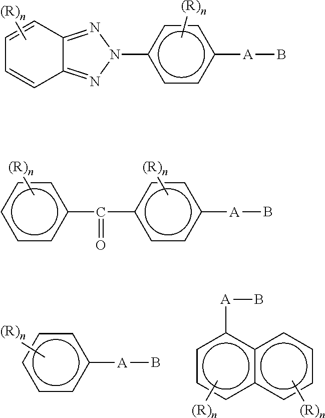

wherein A signifies —NH— or —SO₂— and if A signifies —NH— then B signifies on of the following moieties

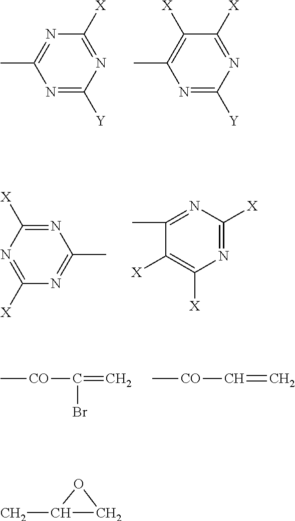

and if B singifies —SO₂— then B signifies on of the following moieties

—CH═CH—OSO₃H

—CH₂—CH₂—OSO₃H

—NH—CH₂—CH₂—OSO₃H

wherein R independently is selected from —OH, —NH₂, —SO₃⁻M⁺, —SO₃H, alkyl, alkoxy, alkanoyl, alkylcarboxylate, —S-alkyl, —CF₃, —N-di-alkyl;
n=0, 1, 2, 3 or 4,
M⁺=cation,
X=H or CI, F, Br and is independently selected,

### Y=X or R.

Preferably the method of increasing the SPF rating of fibers or fabrics comprises applying to the fibers or fabrics one or more compounds of formula

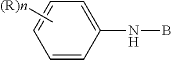

wherein B is selected from one of the following moieties (i) or (ii):

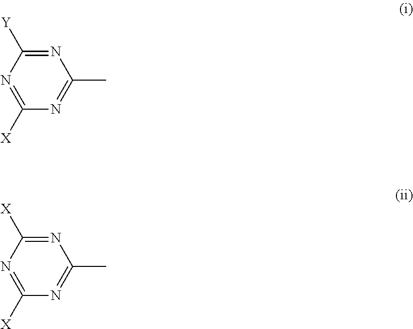

wherein R independently is selected from —OH, —NH₂, —SO₃⁻M⁺, —SO₃H, alkyl, alkoxy, alkanoyl, alkylcarboxylate, —S-alkyl, —CF₃,
n=0, 1, 2, 3 or 4,
M⁺=cation,
X=H or CI, F, Br and is independently selected,

### Y=X or R.

The method of increasing the SPF rating of fibers or fabrics comprises applying to the fibers or fabrics one or more of said compounds an application of less than 3% of a said compound on weight of fiber or fabric produces an SPF rating of greater than 20.

The SPF increasing compounds may be applied to cotton by either exhaustion or pad methods, or by the same methods which are usual for the respective fiber or fabric respectively. SPF increasing compounds may be applied may be applied before, during are after the dyeing. SPF increasing compounds are preferably applied during the dyeing operation.

### Compounds of Formulae

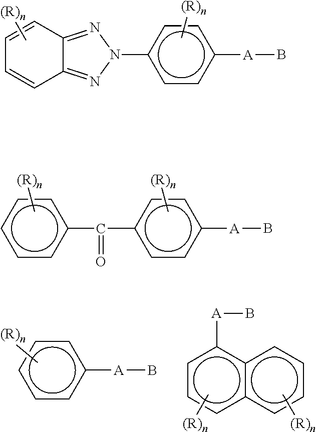

wherein the substituents have the meaning as described above are useful as UVR absorber compounds and can be applied to fabrics of any weight. Typically, they are suitable for application to light weight summer fabrics and to heavier fabric up to and including industrial weight fabrics.

The process for increasing the SPF of the fibers and fabrics comprises the use and the application of the compounds (I) to (IV) as described in WO94/04515.

These compounds as described in WO94/04515 especially the compounds of the formula (I) to (IV) as described in WO94/04515 and the method and process for increasing the SPF of the fibers and fabrics is described in e.g. WO94/04515.

In the description and in the following examples and claims, parts and % are by weight, unless otherwise stated. The examples which follow illustrate the invention.

### EXAMPLE A-1 AND USE EXAMPLE A-A

A dyebath at 40° C., consisting of 2000 parts of water, 1 part of a weakly cation-active levelling agent which is based on an ethoxylated aminopropyl fatty acid amide and which has affinity for dye, 2.2 parts of the dye of C.I. Acid Yellow 218, and adjusted to pH 5 with 1-2 parts of 40% acetic acid is entered with 100 parts of nylon-6,6 fabric. After 10 minutes at 40° C., the dyebath is heated to 98° C. at a rate of 1° C. per minute and then left at the boil for 45-60 minutes. Thereafter it is cooled down to 70° C. over 15 minutes. The dyeing is removed from the bath, rinsed with hot and then with cold water and dried.

The reflectance of the dyed substrate compared with the undyed substrate in the near infrared region is:

| | | Concen- | Reflectance | | |
|---|---|---|---|---|---|
| Substrate | Dye | tration | at 800 nm | 950 nm | 1100 nm |
| Nylsuisse | — | — | 89% | 88% | 87% |
| nylon-6,6 | | | | | |
| wool gabardine | — | — | 85% | 85% | 84% |
| wool gabardine | C.I. Acid | 2.2% | 89% | 88% | 87% |
| | Yellow | | | | |
| | 218 | | | | |

Substrates dyed or printed with C.I. Acid Yellow 218 similarly to Use Examples B-G give the same measured results.

### USE EXAMPLE A-B

A dyebath at 40° C., consisting of 2000 parts of water, 1 part of a weakly cation-active levelling agent which is based on an ethoxylated aminopropyl fatty acid amide and which has affinity for dye, 0.3 part of the dye of Use Example A and adjusted to pH 5.5 with 1-2 parts of 40% acetic acid is entered with 100 parts of nylon-6,6 fabric. After 10 minutes at 40° C., the dyebath is heated to 120° C. at a rate of 1.5° C. per minute and then left at this temperature for 15-25 minutes. Thereafter it is cooled down to 70° C. over 25 minutes. The dyeing is removed from the dyebath, rinsed with hot and then with cold water and dried. The result obtained is a yellow polyamide dyeing with good levelness and having good light and wet fastnesses.

### USE EXAMPLE A-C

A dyebath at 40° C., consisting of 4000 parts of water, 1 part of a weakly amphoteric levelling agent which is based on a sulphated, ethoxylated fatty acid amide and which has affinity for dye, 0.4 part of the abovementioned dye and adjusted to pH 5 with 1-2 parts of 40% acetic acid is entered with 100 parts of wool fabric. After 10 minutes at 40° C., the dyebath is heated to boiling at a rate of 1° C. per minute and then left at the boil for 40-60 minutes. Thereafter it is cooled down to 70° C. over 20 minutes. The dyeing is removed from the bath, rinsed with hot and then with cold water and dried.

### USE EXAMPLE A-D

100 parts of a woven nylon-6 material are padded with a 50° C. liquor consisting of

40 parts of the abovementioned dye,
100 parts of urea,
20 parts of a nonionic solubilizer based on butyldiglycol,
15-20 parts of acetic acid (to adjust the pH to 4),
10 parts of a weakly cation-active levelling agent which is based on an
ethoxylated aminopropyl fatty acid amide and has affinity for dye, and
810-815 parts of water (to make up to 1000 parts of padding liquor).

The material thus impregnated is rolled up and left to dwell in a steaming chamber under saturated steam conditions at 85-98° C. for 3-6 hours for fixation. The dyeing is then rinsed with hot and cold water and dried. The result obtained is a blue nylon dyeing having good levelness in the piece and good light and wet fastnesses.

### USE EXAMPLE A-E

A textile cut pile sheet material composed of nylon-6 and having a synthetic base fabric is padded with a liquor containing per 1000 parts

1 part of the abovementioned dye
4 parts of a commercially available thickener based on carob flour ether
2 parts of a nonionic ethylene oxide adduct of a higher alkylphenol
1 part of 60% acetic acid.

This is followed by printing with a paste which per 1000 parts contains the following components:

20 parts of commercially available alkoxylated fatty alkylamine
(displace product)
20 parts of a commercially available thickener based on carob flour ether.

The print is fixed for 6 minutes in saturated steam at 100° C., rinsed and dried.

### USE EXAMPLE A-F

3 parts of the abovementioned dye are dissolved in 82 parts of demineralized water and 15 parts of diethylene glycol at 60° C. Cooling down to room temperature gives an orange printing ink which is very highly suitable for ink jet printing on paper or polyamide and wool textiles.

### USE EXAMPLE A-G

A dyebath consisting of 1000 parts of water, 80 parts of calcined Glauber salt, 1 part of sodium nitrobenzene-3-sulphonate and 1 part of the abovementioned dye is heated to 80° C. in the course of 10 minutes. Then, 100 parts of mercerized cotton are added. This is followed by dyeing at 80° C. for 5 minutes and then heating to 95° C. in the course of 15 minutes. After 10 minutes at 95° C., 3 parts of sodium carbonate are added, followed by a further 7 parts of sodium carbonate after 20 minutes and another 10 parts of sodium carbonate after 30 minutes at 95° C. Dyeing is subsequently continued at 95° C. for 60 minutes. The dyed material is then removed from the dyebath and rinsed in running demineralized water for 3 minutes. This is followed by two washes for 10 minutes in 5000 parts of boiling demineralized water at a time and subsequent rinsing in running demineralized water at 60° C. for 3 minutes and with cold tap water for one minute.

### EXAMPLES A-2-A-34

Table 1 below contains dyes which were dyed or printed analogously to the use examples described under Example A-1 using the appropriate dyeing auxiliaries, and also the reflectance values of the respective dyed or printed substrates in the near infrared region:

TABLE 1

| | | | | Reflectance | | |
|---|---|---|---|---|---|---|
| Example | Substrate | Dye | Concentration | at 800 nm | 950 nm | 1100 nm |
| A-2 | nylon-6,6 | C.I. Acid | 2.5% | 89% | 88% | 87% |
| | | Red 111 | | | | |
| A-3 | nylon-6,6 | C.I. Acid | 1.5% | 88% | 88% | 87% |
| | | Red 143 | | | | |
| A-4 | nylon-6,6 | C.I. Acid | 2.2% | 75% | 87% | 86% |
| | | Violet 48 | | | | |
| A-5 | nylon-6,6 | C.I. Acid | 1.5% | 89% | 88% | 87% |
| | | Blue 80 | | | | |
| A-6 | nylon-6,6 | C.I. Acid | 2.2% | 89% | 88% | 87% |
| | | Violet 54 | | | | |
| A-7 | nylon-6,6 | C.I. Acid | 1.5% | 89% | 88% | 87% |
| | | Yellow 256 | | | | |
| A-8 | nylon-6,6 | C.I. Acid | 1.5% | 80% | 85% | 87% |
| | | Yellow 199 | | | | |
| A-9 | nylon-6,6 | C.I. Acid | 1.5% | 89% | 88% | 87% |
| | | Yellow 49 | | | | |
| A-10 | nylon-6,6 | C.I. Acid | 2.2% | 87% | 88% | 87% |
| | | Brown 248 | | | | |
| A-11 | nylon-6,6 | C.I. Acid | 1.1% | 88% | 89% | 87% |
| | | Red 57 | | | | |
| A-12 | nylon-6,6 | C.I. Acid | 2.0% | 89% | 88% | 87% |
| | | Violet 126 | | | | |
| A-13 | nylon-6,6 | C.I. Acid | 1.1% | 80% | 88% | 87% |
| | | Blue 324 | | | | |
| A-14 | nylon-6,6 | C.I. Acid | 1.5% | 89% | 88% | 87% |
| | | Blue 45 | | | | |
| A-15 | nylon-6,6 | C.I. Acid | 1.5% | 89% | 88% | 87% |
| | | Yellow 42 | | | | |
| A-16 | nylon-6,6 | C.I. Acid | 3.0% | 89% | 89% | 87% |
| | | Red 260 | | | | |
| A-17 | nylon-6,6 | C.I. Acid | 3.0% | 89% | 88% | 87% |
| | | Red 415 | | | | |
| A-18 | nylon-6,6 | C.I. Acid | 2.5% | 87% | 88% | 87% |
| | | Orange 116 | | | | |
| A-19 | nylon-6,6 | C.I. Acid | 3.0% | 80% | 84% | 86% |
| | | Blue 280 | | | | |
| A-20 | nylon-6,6 | C.I. Acid | 2.0% | 85% | 88% | 87% |
| | | Green 25 | | | | |
| A-21 | nylon-6,6 | C.I. Acid | 2.5% | 89% | 88% | 87% |
| | | Yellow 236 | | | | |
| A-22 | wool | C.I. Acid | 2.0% | 81% | 81% | 81% |
| | gabardine | Yellow 236 | | | | |
| A-23 | nylon-6,6 | Nylosan Rot | 2.0% | 86% | 87% | 87% |
| | | S-3B | | | | |
| A-24 | wool | Nylosan Rot | 4.0% | 81% | 85% | 84% |
| | gabardine | S-3B | | | | |
| A-25 | nylon-6,6 | Nylosan | 0.5% | 77% | 81% | 85% |
| | | Navy S-3G | | | | |
| A-26 | wool | Nylosan | 0.5% | 80% | 83% | 84% |
| | gabardine | Navy S-3G | | | | |
| A-27 | nylon-6,6 | C.I. Acid | 1.5% | 89% | 88% | 87% |
| | | Yellow 17 | | | | |
| A-28 | nylon-6,6 | C.I. Acid | 3.0% | 89% | 88% | 87% |
| | | Yellow 172 | | | | |
| A-29 | nylon-6,6 | C.I. Acid | 1.0% | 88% | 88% | 87% |
| | | Red 37 | | | | |
| A-30 | nylon-6,6 | C.I. Acid | 2.2% | 87% | 88% | 87% |
| | | Yellow 19 | | | | |
| A-31 | nylon-6,6 | C.I. Acid | 1.1% | 86% | 88% | 87% |
| | | Blue 182 | | | | |
| A-32 | nylon-6,6 | C.I. Acid | 2.0% | 89% | 88% | 87% |
| | | Red 145 | | | | |
| A-33 | nylon-6,6 | C.I. Acid | 2.0% | 89% | 88% | 87% |
| | | Red 249 | | | | |
| A-34 | nylon-6,6 | C.I. Acid | 2.0% | 85% | 88% | 87% |
| | | Blue 129 | | | | |

### EXAMPLE B-1 (DYED IN ACCORDANCE WITH USE EXAMPLE B-A)

0.55 part of C.I. Basic Blue 22 is dissolved in 250 parts of demineralized water. 0.5 part of Ekalin F and 0.2 part of sodium acetate are added and the pH is adjusted to 4.5 with acetic acid. The dyebath is heated to 65° C. and entered with 10 parts of Orlon 75. The dyebath is then heated to 80° C. at a rate of 1° C./min and then to 105° C. at 0.5-1° C./min. Dyeing is continued at 105° C. for 60 min. The dyed fabric is then rinsed for 3 minutes with running cold water and subsequently for 3 minutes with running hot water and thereafter centrifuged and dried in a drying cabinet at 60° C.

The reflectance of the dyed substrate compared with the undyed substrate in the near infrared region is:

| | | Concen- | Reflectance | | |
|---|---|---|---|---|---|
| Substrate | Dye | tration | at 800 nm | 950 nm | 1100 nm |
| Orlon 75 | — | — | 90% | 90% | 90% |
| ″ | C.I. Basic | 1.1% | 86% | 89% | 89% |
| | Blue 22 | | | | |

### EXAMPLES B-2-B-35

Table 2 below contains dyes which were dyed on Orlon 75 analogously to the Use Example B-A described under Example B-1 using the appropriate dyeing auxiliaries, and also the reflectance values of the respective dyed or printed substrates in the near infrared region:

TABLE 2

| | | Concen- | Reflectance | 950 | 1100 |
|---|---|---|---|---|---|
| Example | Dye | tration | at 800 nm | nm | nm |
| B-2 | C.I. Basic Blue 1 | 1.5% | 86% | 88% | 89% |
| B-3 | C.I. Basic Blue 3 | 1.0% | 85% | 85% | 86% |
| B-4 | C.I. Basic Blue 26 | 2.2% | 88% | 89% | 89% |
| B-5 | C.I. Basic Blue 67 | 0.8% | 86% | 86% | 85% |
| B-6 | C.I. Basic Blue 11 | 0.8% | 87% | 85% | 84% |
| B-7 | C.I. Basic Yellow 1 | 1.0% | 86% | 86% | 86% |
| B-8 | C.I. Basic Yellow 2 | 1.5% | 86% | 86% | 86% |
| B-9 | C.I. Basic Yellow 13 | 1.0% | 88% | 86% | 86% |
| B-10 | C.I. Basic Yellow 106 | 0.8% | 85% | 85% | 86% |
| B-11 | C.I. Basic Yellow 90 | 1.1% | 86% | 86% | 86% |
| B-12 | C.I. Basic Orange 2 | 1.5% | 90% | 90% | 90% |
| B-13 | C.I. Basic Orange 30 | 1.1% | 86% | 86% | 86% |
| B-14 | C.I. Basic Red 1:1 | 1.5% | 88% | 86% | 86% |
| B-15 | C.I. Basic Red 13 | 0.8% | 85% | 85% | 86% |
| B-16 | C.I. Basic Red 18 | 1.5% | 85% | 85% | 86% |
| B-17 | C.I. Basic Red 46 | 1.1% | 85% | 85% | 86% |
| B-18 | C.I. Basic Green 1 | 1.0% | 84% | 85% | 86% |
| B-19 | C.I. Basic Green 4 | 1.0% | 88% | 86% | 86% |
| B-20 | C.I. Basic Brown 1 | 0.8% | 85% | 85% | 86% |

### EXAMPLE C-1 AND USE EXAMPLE C-A

17.5 parts of the dye C.I. Disperse Yellow 42 in the form of the moist presscake are wet ground by a known method with 32.5 parts of a commercially available dispersant based on ligninsulphonates and pulverized to a powder. 1.2 parts of this dyeing preparation are added to 2000 parts of demineralized water at 70° C., which contain 40 parts of ammonium sulphate. The pH of the dyebath is set to 5 with 85% formic acid. This dyebath is entered with 100 parts of cleaned woven polyester fibre fabric, the apparatus is sealed, and the temperature is raised to 130° C. in the course of 20 min and dyeing is continued at 130° C. for a further 40 min. After cooling, the woven polyester fibre fabric is removed from the dyebath, rinsed, soaped and reduction cleared in a conventional manner with sodium hydrosulphite. After thermofixing (180° C., 30 sec), a brilliant yellow dyeing is obtained with very good all-round fastness, especially fastness to light and sublimation, especially excellent wet fastness.

### USE EXAMPLE C-B

2.5 parts of the abovementioned dye are dissolved in a mixture of 20 parts of diethylene glycol and 77.5 parts of water at 25° C. with stirring to obtain a printing ink suitable for inkjet printing.

### USE EXAMPLE C-C

A printing paste according to the invention consists of

500 g of a thickener (bean gum ether, for example Indalca ®),
10 g of a fixation accelerant (e.g. Printogen ® HDN liq.),
10 g of a levelling agent (e.g. Lyogen ® CN liq.),
10 g of a buffering and dispersant system, for dyeing
(e.g. Opticid ® PB; 1:2) and also
10 g of C.I. Disperse Yellow 42
and water ad 1000 g.
(Indalca was purchased from Cesalpinia S.p.A., Italy; Lyogenn, Printogen and Opticid are trademarks of Clariant AG, Muttenz, Switzerland).

This printing paste is used for printing papery substrates, textile fibre materials and plastic films and plastic transparencies.

### USE EXAMPLE C-D

A polyester interlock fabric was printed with a conventional printing machine using the printing paste of USE EXAMPLE C-C. The printed fabric obtained is dried at 110° C. for 3 minutes and then treated with hot steam at 175° C. for 7 minutes. The fabric is rinsed with cold tap water for 5 minutes and then with demineralized water for 5 minutes. The fabric thus treated was reduction cleared in a bath containing 4 g/l of Na₂CO₃, 2 g/l of hydrosulphite sodium salt (85%) and 1 g/l of Lyogen® DFT (trade mark of Clariant AG, Muttenz, Switzerland). Further rinsing for 15 minutes with tap water was followed by a final drying step. This leaves a polyester fabric having a brilliant red print with very good all-round fastness, especially fastness to light and sublimation, in particular excellent wetfastness.

### USE EXAMPLE C-E

The inkjet printing composition is preferably prepared by heating the medium to 40° C. and then adding the abovementioned dye. The mixture is stirred until the dyes are dissolved. The composition is then cooled down to room temperature and the further ingredients are added.

The fractions of the individual components of the ink compositions

6 parts of C.I. Disperse Yellow 42,
20 parts of glycerol and
74 parts of water.

This ink composition is used for printing papery substrates, textile fibre materials and plastic films and plastic transparencies.

### USE EXAMPLE C-F

A polyester interlock fabric was inkjet printed using the printing ink of USE EXAMPLE C-E. The printed fabric was treated analogously to the post printing treatment of USE EXAMPLE C-D. This gives a polyester fabric with a brilliant red print with very good all-round fastness, especially fastness to light and sublimation, in particular excellent wetfastness.

The reflectance of the dyed substrate compared with the undyed substrate in the near infrared region is:

| | | Concen- | Reflectance | | |
|---|---|---|---|---|---|
| Substrate | Dye | tration | at 800 nm | 950 nm | 1100 nm |
| Polyester, | — | — | 85% | 83% | 82% |
| Tersuisse 9046 | | | | | |
| Polyester, | C.I. | 1.5% | 89% | 89% | 87% |
| Tersuisse 9046 | Disperse | | | | |
| | Yellow 42 | | | | |

### EXAMPLES C-2-C-35

Table 3 below contains dyes which were dyed or printed on polyester analogously to the use examples C-A to C-F described under Example C-1 using the appropriate dyeing auxiliaries, and also the reflectance values of the respective dyed or printed substrates in the near infrared region:

TABLE 3

| Exam- | | Concen- | Reflectance | 950 | 1100 |
|---|---|---|---|---|---|
| ple | Dye | tration | at 800 nm | nm | nm |
| C-2 | C.I. Disperse Orange 30 | 2.5% | 86% | 86% | 86% |
| C-3 | C.I. Disperse Red 73 | 2.0% | 86% | 86% | 86% |
| C-4 | C.I. Disperse Red 60 | 0.5% | 91% | 90% | 90% |
| C-5 | C.I. Disperse Blue 56 | 0.8% | 86% | 86% | 85% |
| C-6 | C.I. Disperse Blue 73 | 0.8% | 87% | 85% | 84% |
| C-7 | C.I. Disperse Yellow 64 | 1.0% | 86% | 86% | 86% |
| C-8 | C.I. Disperse Blue 354 | 1.0% | 85% | 86% | 85% |
| C-9 | C.I. Disperse Red 86 | 1.1% | 93% | 89% | 89% |
| C-10 | C.I. Disperse Violet 27 | 1.1% | 89% | 89% | 89% |
| C-11 | C.I. Disperse Red 167:1 | 2.5% | 86% | 86% | 86% |
| C-12 | C.I. Disperse Blue 60 | 0.4% | 84% | 88% | 88% |
| C-13 | C.I. Disperse Yellow 23 | 1.1% | 86% | 86% | 86% |
| C-14 | C.I. Solvent Yellow 163 | 1.5% | 90% | 90% | 90% |
| C-15 | C.I. Disperse Blue 79 | 0.8% | 88% | 86% | 86% |
| C-16 | C.I. Disperse Yellow 231 | 1.0% | 85% | 85% | 86% |
| C-17 | C.I. Disperse Violet 63 | 0.5% | 85% | 85% | 86% |
| C-18 | C.I. Disperse Blue 87 | 1.0% | 84% | 85% | 86% |
| C-19 | C.I. Disperse Blue 291 | 1.0% | 88% | 86% | 86% |
| C-20 | C.I. Disperse Blue 3 | 1.5% | 86% | 86% | 86% |
| C-21 | C.I. Disperse Red 227 | 1.0% | 88% | 86% | 86% |
| C-22 | C.I. Disperse Orange 13 | 0.8% | 85% | 85% | 86% |
| C-23 | C.I. Disperse Red 72 | 1.5% | 90% | 90% | 90% |
| C-24 | C.I. Disperse Orange 62 | 1.1% | 90% | 90% | 90% |
| C-25 | C.I. Disperse Yellow 88 | 1.0% | 86% | 86% | 86% |
| C-26 | C.I. Disperse Blue 85 | 2.5% | 85% | 88% | 88% |
| C-27 | C.I. Disperse Blue 165 | 1.1% | 86% | 88% | 88% |
| C-28 | C.I. Disperse Yellow 82 | 0.8% | 84% | 86% | 88% |
| C-29 | C.I. Disperse Yellow 162 | 1.0% | 86% | 86% | 86% |
| C-30 | C.I. Disperse Red 91 | 1.1% | 84% | 88% | 88% |
| C-31 | C.I. Disperse Red 92 | 1.0% | 86% | 86% | 86% |
| C-32 | C.I. Disperse Blue 94 | 1.5% | 86% | 88% | 89% |
| C-33 | C.I. Disperse Yellow 93 | 1.0% | 85% | 85% | 86% |
| C-34 | C.I. Disperse Orange 32 | 2.2% | 88% | 89% | 89% |

### EXAMPLE D-1 (DYED IN ACCORDANCE WITH USE EXAMPLE D-A)

100 parts of polyacrylonitrile pellet are dry-mixed with 1 part of C.I. Pigment Yellow 213. The pellet thus incipiently coloured dry is at 260-265° C. homogenized in an extruder and extruded into fibres. The yellow polyacrylonitrile fibres obtained are wound up on a bobbin.

Repeating the above procedure with the addition of 1% of titanium dioxide gives a yellow hiding dye.

The reflectance of the dyed substrate compared with the undyed substrate in the near infrared region is:

| | | Trans- | Reflect- | | |
|---|---|---|---|---|---|
| | | parent | ance | | |
| | | (T) or | at | 940 | 1100 |
| Substrate | Dye | hiding (H) | 800 nm | nm | nm |
| Polyacrylonitrile | — | — | | | |
| Polyacrylonitrile | C.I. Pigment | H | 88.4% | 83.3% | 84.2% |
| | Yellow 213 | | | | |
| Polyacrylonitrile | C.I. Pigment | T | 81.8% | 75.1% | 76.1% |
| | Yellow 213 | | | | |

### EXAMPLES D-2-D-7

Table 4 below contains dyes with which polyacrylonitrile was dyed analogously to Use Example D-A described under Example D-1 or another established method for mass coloration spin dyeing, and also the reflectance values of the respective dyed substrates in the near infrared region:

TABLE 4

| Exam- | | Reflectance | | |
|---|---|---|---|---|
| ple | Dye | at 800 nm | 950 nm | 1100 nm |
| D-2 | C.I. Pigment Red 168 | 85.7% (H) | 82.8% (H) | 83.7% (H) |
| | | 78.8% (T) | 74.7% (T) | 75.7% (T) |
| D-3 | C.I. Pigment Red 257 | 83.7% (H) | 79.8% (H) | 82.7% (H) |
| | | 75.9% (T) | 70.9% (T) | 74.2% (T) |
| D-4 | C.I. Pigment Orange 43 | 88.8% (H) | 83.8% (H) | 84.5% (H) |
| | | 83.2% (T) | 77.4% (T) | 78.1% (T) |
| D-5 | C.I. Pigment Red 149 | 83.9% (H) | 81.2% (H) | 83.0% (H) |
| | | 73.2% (T) | 69.1% (T) | 69.9% (T) |
| D-6 | C.I. Pigment Yellow 191 | 84.7% (H) | 82.8% (H) | 85.7% (H) |
| | | 79.8% (T) | 75.7% (T) | 76.9% (T) |
| D-7 | C.I. Pigment Yellow 120 | 88.2% (H) | 85.8% (H) | 87.7% (H) |
| | | 79.8% (T) | 76.0% (T) | 77.7% (T) |

### EXAMPLE E-1 AND USE EXAMPLE E-A

1.5 parts of the dye C.I. Reactive Red 123 are dissolved in 100 parts of demineralized water and 8 parts of Glauber salt (calcined) are added. The dyebath is heated to 50° C. and 10 parts of cotton fabric (bleached) are added. The temperature is maintained at 50° C. during the addition of sodium carbonate. The dyebath is then heated to 60° C. and the dyeing is continued at 60° C. for one hour. The dyed fabric is then rinsed with running cold water for 3 minutes and then with running hot water for 3 minutes. The dyed fabric is then washed in boiling hot demineralized water in the presence of 0.25 part of Marseille soap for 15 minutes. After a further 3 minute rinse with running hot water and a subsequent centrifugation, the dyed fabric is dried in a drying cabinet at 70° C.

### USE EXAMPLE E-B

A dyebath containing 100 parts of demineralized water and 5 parts of Glauber salt is entered with 10 parts of cotton fabric (bleached).

The bath is then heated to 50° C. over 10 minutes and subsequently 0.5 part of the abovementioned dye is added. After a further 30 minutes at 50° C. 1 part of sodium carbonate (calcined) is added. The dyebath is then heated to 60° C. and the dyeing is continued at 60° C. for a further 45 minutes.

The dyed fabric is rinsed first with running cold water and then with hot water and subsequently washed as in Use Example E-A.

### USE EXAMPLE E-C

A printing paste consisting of

40 parts of the abovementioned dye
100 parts of urea
350 parts of water
500 parts of a 4% sodium alginate thickener and
10 parts of sodium bicarbonate
1000 parts in total

is applied to cotton fabric by known methods. The printed fabric is dried and fixed in steam at 102-104° C. for 4-8 minutes.

It is then rinsed first with cold and then with hot water. It is subsequently washed in boiling water as described in Use Example E-A and then dried. The result is a violet dyeing having very good light and wet fastnesses, which is stable to oxidative influences.

### USE EXAMPLE E-D

2.5 parts of the abovementioned dye are stirred into a mixture of 20 parts of diethylene glycol and 77.5 parts of water at 25° C. The result is a printing ink useful for the inkjet printing process.

The reflectance of the dyed substrate compared with the undyed substrate in the near infrared region is:

| | | Concen- | Reflectance | | |
|---|---|---|---|---|---|
| Substrate | Dye | tration | at 800 nm | 950 nm | 1100 nm |
| Cotton | — | — | 91% | 90% | 90% |
| interlock, | | | | | |
| bleached | | | | | |
| Cotton | C.I. Reactive | 1.5% | 91% | 90% | 90% |
| interlock, | Red 123 | | | | |
| bleached | | | | | |

### EXAMPLES E-2-E-23

Table 5 below contains dyes which were dyed or printed analogously to the Use Examples described under Example E1 using the appropriate dyeing auxiliaries, and also the reflectance values of the respective dyed or printed substrates in the near infrared region:

TABLE 5

| Exam- | | | Concen- | Reflectance | 950 | 1100 |
|---|---|---|---|---|---|---|
| ple | Substrate | Dye | tration | at 800 nm | nm | nm |
| E-2 | Cotton | C.I. Reactive | 2.0% | 91% | 90% | 90% |
| | interlock, | Black 5 | | | | |
| | bleached | | | | | |
| E-3 | Cotton | C.I. Reactive | 2.0% | 91% | 92% | 92% |
| | interlock, | Black 39 | | | | |
| | bleached | | | | | |
| E-4 | Cotton | C.I. Reactive | 3.0% | 91% | 92% | 92% |
| | interlock, | Yellow 13 | | | | |
| | bleached | | | | | |
| E-5 | Cotton | C.I. Reactive | 1.8% | 92% | 93% | 92% |
| | interlock, | Yellow 174 | | | | |
| | bleached | | | | | |
| E-6 | Cotton | C.I. Reactive | 2.0% | 91% | 92% | 92% |
| | interlock, | Red 198 | | | | |
| | bleached | | | | | |
| E-7 | Cotton | C.I. Reactive | 2.2% | 91% | 92% | 92% |
| | interlock, | Red 241 | | | | |
| | bleached | | | | | |
| E-8 | Cotton | C.I. Reactive | 1.5% | 92% | 93% | 92% |
| | interlock, | Blue 166 | | | | |
| | bleached | | | | | |
| E-9 | Cotton | C.I. Reactive | 2.0% | 91% | 92% | 92% |
| | interlock, | Blue 225 | | | | |
| | bleached | | | | | |
| E-10 | Cotton | C.I. Reactive | 2.0% | 92% | 93% | 92% |
| | interlock, | Blue 238 | | | | |
| | bleached | | | | | |
| E-11 | Cotton | C.I. Reactive | 1.8% | 90% | 92% | 92% |
| | interlock, | Orange 12 | | | | |
| | bleached | | | | | |
| E-12 | Cotton | C.I. Reactive | 3.0% | 92% | 93% | 92% |
| | interlock, | Orange 16 | | | | |
| | bleached | | | | | |
| E-13 | Cotton | C.I. Reactive | 2.8% | 91% | 92% | 92% |
| | interlock, | Orange 64 | | | | |
| | bleached | | | | | |
| E-14 | Cotton | C.I. Reactive | 1.8% | 90% | 92% | 92% |
| | interlock, | Orange 72 | | | | |
| | bleached | | | | | |
| E-15 | Cotton | C.I. Reactive | 2.0% | 92% | 93% | 92% |
| | interlock, | Brown 2 | | | | |
| | bleached | | | | | |
| E-16 | Cotton | Drimaren | 2.0% | 92% | 93% | 92% |
| | interlock, | Yellow | | | | |
| | bleached | HF-R | | | | |
| E-17 | Cotton | Drimaren | 2.6% | 91% | 92% | 92% |
| | interlock, | Orange | | | | |
| | bleached | HF-2GL | | | | |
| E-18 | Cotton | Drimaren | 1.6% | 92% | 93% | 93% |
| | interlock, | Scarlet | | | | |
| | bleached | HF-3G | | | | |
| E-19 | Cotton | Drimaren | 1.9% | 91% | 92% | 92% |
| | interlock, | Red HF-G | | | | |
| | bleached | | | | | |
| E-20 | Cotton | Drimaren | 3.7% | 91% | 92% | 92% |
| | interlock, | Red HF-2B | | | | |
| | bleached | | | | | |
| E-21 | Cotton | Drimaren | 3.2% | 91% | 92% | 92% |
| | interlock, | Brown | | | | |
| | bleached | HF-2RL | | | | |
| E-22 | Cotton | Drimaren | 1.0% | 89% | 91% | 91% |
| | interlock, | Navy HF-B | | | | |
| | bleached | | | | | |
| E-23 | Cotton | Drimaren | 1.8% | 89% | 91% | 91% |
| | interlock, | Navy HF-G | | | | |
| | bleached | | | | | |

1. A method for minimally reducing, retaining or increasing the NIR reflectance, in the region of electromagnetic radiation of wavelength 700 nm to 1100 nm of a printed or dyed textile material in relation to the undyed and untreated textile material, comprising the step of dyeing or printing the textile material with a metal-free dye.

2. The method according to claim 1, wherein the NIR reflectance, in the region of electromagnetic radiation of wavelength 700 nm to 1100 nm of textile material in relation to the undyed and untreated textile material is increased.

3. The method according to claim 2, wherein the dye has one of the following structures (A-I), (A-II), (A-III), (A-IV) or (A-V) 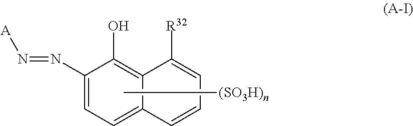
where
A is an unsubstituted or substituted naphthyl radical or an unsubstituted or substituted phenyl radical,
R³² is hydrogen, hydroxyl, amino or an unsubstituted or substituted naphthyl radical or an unsubstituted or substituted phenyl radical, and
n is 1, 2 or 3, 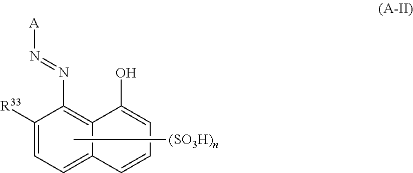
where
A is an unsubstituted or substituted naphthyl radical or an unsubstituted or substituted phenyl radical,
R³³ is hydrogen, hydroxyl, amino or an unsubstituted or substituted naphthyl radical or an unsubstituted or substituted phenyl radical, and
n is 1, 2 or 3, 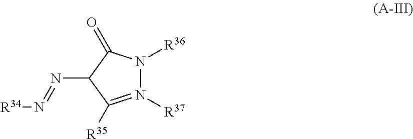
where
R³⁴, R³⁵, R³⁶, R³⁷ are each hydrogen, hydroxyl, amino, substituted or unsubstituted C₁ to C₄ alkyl, or an unsubstituted or substituted naphthyl radical or an unsubstituted or substituted phenyl radical and the dye of formula (III) includes one, two or three sulpho groups, 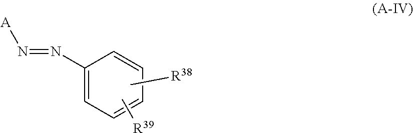
where
A, R³⁸, R³⁹ are each hydrogen, hydroxyl, amino, substituted or unsubstituted C₁ to C₄ alkyl, or an unsubstituted or substituted naphthyl radical or an unsubstituted or substituted phenyl radical and the dye of formula (IV) includes one, two or three sulpho groups, 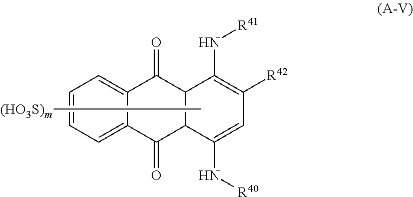
where
R⁴⁰, R⁴¹, R⁴² are each hydrogen, hydroxyl, amino, substituted or unsubstituted C₁ to C₄ alkyl, or an unsubstituted or substituted naphthyl radical or an unsubstituted or substituted phenyl radical,
m is 0, 1, 2 or 3 and the dye of formula (A-V) includes one, two or three sulpho groups,
or have one of the following structures (B-I), (B-II), (B-III), (B-IV) or (B-V) 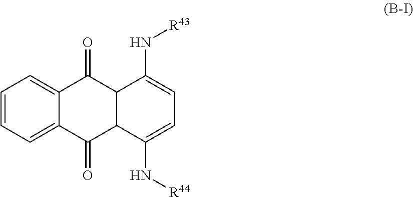
where
R⁴³ and R⁴⁴ are independently substituted or unsubstituted C₁ᵢ to C₄ alkyl, substituted or unsubstituted —(C₁₋₄ alkylene)-N⁺-(C₁₋₄ alkyl)₂, the dye of the formula (B-I) being at least singly or doubly positively charged; 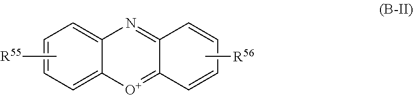
where
R⁵⁵ and R⁵⁶ are independently substituted or unsubstituted C₁ to C₄ alkyl, substituted or unsubstituted —N—(C₁₋₄ alkyl)₂; 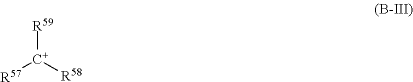
where
R⁵⁷ and R⁵⁸ are independently substituted or unsubstituted phenyl, substituted or unsubstituted naphthyl, and
R⁵⁹ is independently substituted or unsubstituted phenyl, substituted or unsubstituted naphthyl or ═N⁺H₂; 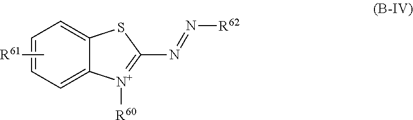
where
R⁶⁰ is (C₁₋₄ alkyl)-C(O)NH₂
R⁶¹ is (C₁₋₄ alkyl or (C₁₋₄ alkoxy, and
R⁶² is substituted or unsubstituted phenyl, substituted or unsubstituted naphthyl,
or have the following dyes of the formula (C-1) or (C-2) or (C-3) or (C-4) or (C-5) or (C-6) or (C-7) or (C-8) or (C-9) or (C-10) or (C-11) or (C-12): 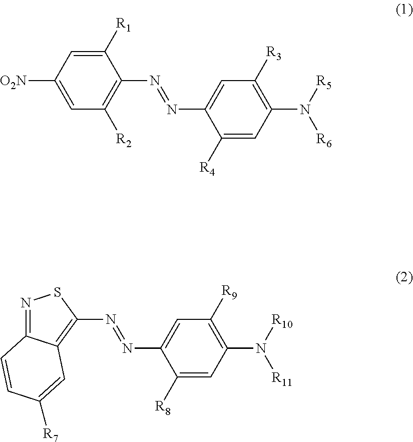
where
R₁ is hydrogen, halogen, nitro or cyano
R₂ is hydrogen, halogen, nitro or cyano
R₃ is hydrogen, halogen, C₁-C₄-alkoxy or C₁-C₄-alkyl
R₄ is hydrogen or C₁-C₄-alkyl,
R₅ is hydrogen, unsubstituted or hydroxyl-, cyano-, C₁-C₄-alkylcarbonyloxy-substituted C₁-C₄-alkyl or C₁-C₄-alkenyl,
R₆ is unsubstituted or hydroxyl-, cyano-, C₁-C₄-alkylcarbonyloxy-, C₁-C₄-alkoxycarbonyl-substituted C₁-C₄-alkyl or C₁-C₄-alkenyl,
R₇ is nitro, C₁-C₄-alkoxy or the radical —SO₂CH₃,
R₈ is hydrogen or C₁-C₄-alkyl,
R₉ is hydrogen or C₁-C₄-alkyl,
R₁₀ is unsubstituted or hydroxyl- or cyano-substituted C₁-C₄-alkyl,
R₁₁ is unsubstituted C₁-C₄-alkyl or C₁-C₄-alkyl substituted by the radical —O—COR₁₂, where R₁₂ is C₁-C₄-alkyl; 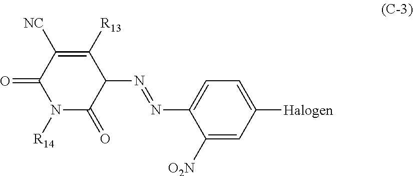
where
R₁₃ is C₁-C₄-alkyl,
R₁₄ is C₁-C₄-alkyl, and
Halogen represents the halogen atoms; 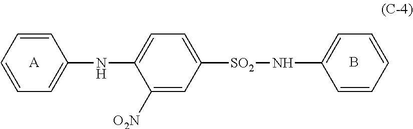
where the rings A and B are, optionally, further substituted; 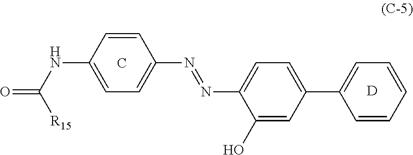
where
R₁₅ is C₁-C₄-alkyl and
the rings C and D are, optionally, further substituted; 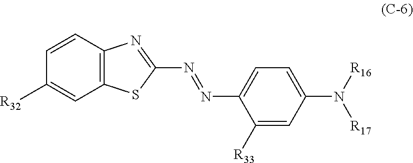
where
R₁₆ is unsubstituted or hydroxyl- or cyano-substituted C₁-C₄-alkyl,
R₁₇ is unsubstituted C₁-C₄-alkyl or C₁-C₄-alkyl substituted by the radical —O—COR₁₈, where R₁₈ is C₁-C₄-alkyl,
R₃₂ is nitro, C₁-C₄-alkoxy or the radical —SO₂CH₃, and
R₃₃ is hydrogen or C₁-C₄-alkyl; 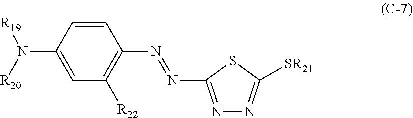
where
R₁₉ is C₁-C₄-alkyl,
R₂₀ is C₁-C₄-alkyl,
R₂₁ is C₁-C₄-alkyl, and
R₂₂ is C₁-C₄-alkyl or the radical —NHCOR₂₃ where R₂₃ is C₁-C₄-alkyl; 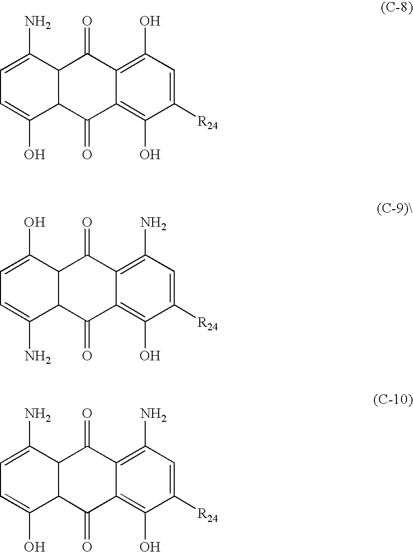
where R₂₄ is halogen; 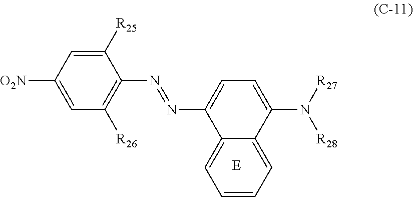
where
R₂₅ is cyano, nitro or halogen,
R₂₆ is halogen,
R₂₇ is unsubstituted or hydroxyl-substituted C₁-C₄-alkyl, and
R₂₈ is unsubstituted or hydroxyl-substituted C₁-C₄-alkyl, and
the naphthyl ring E is, optionally, further substituted, 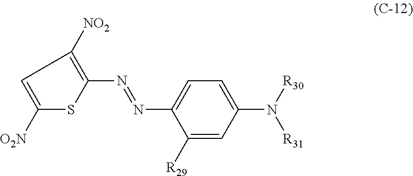
where
R₂₉ is C₁-C₄-alkyl or the radical NHCOR₁₇ where R₁₇ is C₁-C₄-alkyl,
R₃₀ is C₁-C₄-alkyl or C₁-C₄-alkylcarbonyloxy-C₁-C₄-alkyl, and
R₃₁ is C₁-C₄-alkyl or C₁-C₄-alkylcarbonyloxy-C₁-C₄-alkyl
or mixtures thereof,
or have one of the following structures (E-I), (E-II), (E-III), (E-IV), (E-V) or (E-VI) 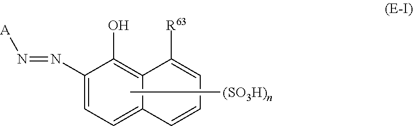
where
A is an unsubstituted or substituted naphthyl radical or an unsubstituted or substituted phenyl radical,
R⁶³ is hydrogen, hydroxyl, amino, an amine substituted by unsubstituted or substituted naphthyl or by unsubstituted or substituted phenyl, or an unsubstituted or substituted naphthyl radical or an unsubstituted or substituted phenyl radical,
n is 1 or 2 and the dye of formula (E-I) includes one or two fibre-reactive groups; 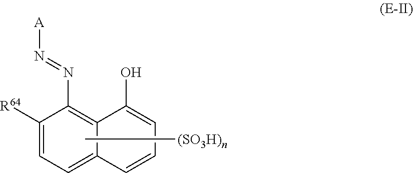
where
A is an unsubstituted or substituted naphthyl radical or an unsubstituted or substituted phenyl radical,
R⁶⁴ is hydrogen, hydroxyl, amino, an amine substituted by unsubstituted or substituted naphthyl or by unsubstituted or substituted phenyl, or an unsubstituted or substituted naphthyl radical or an unsubstituted or substituted phenyl radical,
n is 1, 2 or 3 and the dye of formula (E-II) includes one or two fibre-reactive groups; 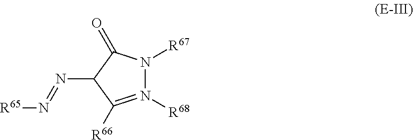
where
R⁶⁵, R⁶⁶, R⁶⁷, R⁶⁸ are each hydrogen, hydroxyl, amino, substituted or unsubstituted C₁ to C₄ alkyl, or an unsubstituted or substituted naphthyl radical or an unsubstituted or substituted phenyl radical and the dye of formula (E-III) includes one, two or three sulpho groups and also one or two fibre-reactive groups; 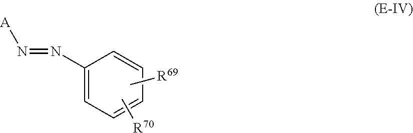
where
A, R⁶⁹, R⁷⁰ are each hydrogen, hydroxyl, amino, an amine substituted by unsubstituted or substituted naphthyl or by unsubstituted or substituted phenyl, or an unsubstituted or substituted naphthyl radical or an unsubstituted or substituted phenyl radical and the dye of formula (E-IV) includes one, two or three sulpho groups and also one or two fibre-reactive groups; 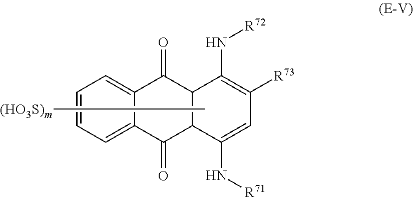
where
R⁷¹, R⁷², R⁷³ are each hydrogen, hydroxyl, amino, substituted or unsubstituted C₁ to C₄ alkyl, or an unsubstituted or substituted naphthyl radical or an unsubstituted or substituted phenyl radical,
m is 0, 1, 2 or 3 and the dye of formula (E-V) includes one, two or three sulpho groups and also one or two fibre-reactive groups; 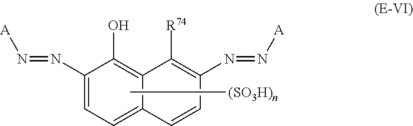
where
A in each occurrence is independently an unsubstituted or substituted naphthyl radical or an unsubstituted or substituted phenyl radical,
R⁷⁴ is hydroxyl, amino, an amine substituted by unsubstituted or substituted naphthyl or by unsubstituted or substituted phenyl, or an unsubstituted or substituted naphthyl radical or an unsubstituted or substituted phenyl radical,
n is 1 or 2 and the dye of formula (E-VI) includes one or two fibre-reactive groups,
or are the dyes are metal-free pigments.

4. A textile material, made in accordance with the method of claim 1.

5. A method for increasing the NIR reflectance, in the region of electromagnetic radiation of wavelength 700 nm to 1100 nm of a printed or dyed textile material in relation to the undyed and untreated textile material, comprising the step of dyeing or printing the textile material with a metal-free dye.

6. A textile material made in accordance with the method of claim 5.
